(19) United States
(12) Patent Application Publication
(10) Pub. No.: US 2008/0158069 A1
(43) Pub. Date: Jul. 3, 2008

(54) INTEGRATED TUNABLE MICRO-ANTENNA WITH SMALL ELECTRICAL DIMENSIONS AND MANUFACTURING METHOD THEREOF

(75) Inventors: Paulo Mateus Mendes, Braga (PT); Jose Higino Gomes Correia, Braga (PT)

Correspondence Address: SUGHRUE MION, PLLC, 2100 PENNSYLVANIA AVENUE, N.W., SUITE 800, WASHINGTON, DC, 20037, US

(73) Assignee: UNIVERSIDADE DO MINHO, Braga (PT)

(21) Appl. No.: 11/966,111

(22) Filed: Dec. 28, 2007

Related U.S. Application Data
(63) Continuation of application No. PCT/IB2006/052190, filed on Jun. 29, 2006.

(30) Foreign Application Priority Data
Jun. 29, 2005 (PT) 103299

(51) Int. Cl. H01Q 9/04; H01P 11/00

(52) U.S. Cl. 343/700 MS; 29/600

(57) ABSTRACT

The present invention describes a tunable micro-antenna of reduced electrical dimensions. This antenna consists of the agglutination of several substrate layers (11), identical or distinct, with electrical, thermal and mechanical properties compatible with the manufacturing processes of integrated circuits. These layers are interleaved with metallic sheets (12) that are interconnected by metallized walls or vias, in such a way that they form a radiating structure (15) and a ground plane (14). The radiating structure includes slots in one or more levels, therefore allowing a greater reduction of the antennas' electrical length. These slots may include switches, used to render the antenna tunable. Since the entire manufacturing method is compatible with the wafer level packaging technology, the micro-antenna is easily integrable in microsystems requiring wireless communication

### CROSS REFERENCE TO RELATED APPLICATIONS

This application is a Continuation of International Application No. PCT/IB2006/052190 filed on Jun. 29, 2006, claiming priority based on Portuguese Patent Application No. 103299, filed Jun. 29, 2005, the contents of a of which are incorporated herein by reference in their entirety.

### SCOPE OF THE INVENTION

The present invention is generically related to the field of microsystems with wireless communication, and particularly with integrated micro-antennas for wireless Microsystems.

### STATE OF THE ART

The availability of several small personal wireless communicating devices and their potential for large-scale utilization, has been taking them to an exponential grow of popularity. This is happening especially in handheld wireless devices, such as mobile phones or in integrated circuits for Bluetooth, where an integrated antenna is usually desired. The wireless sensor network is another new emerging technology, where a high number of sm devices have the ability to gather information about the surrounding environment, transmitting subsequently this information via wireless communication.

These modem wireless communicating systems will become the more popular the smaller, discrete and cheaper they become. Such goal will require more and more often the use of micro-devices, where small and cheap antennas should be integrated.

It is well known that planar structures, like microstrip antennas, present a significant number of advantages when compared to conventional antennas, such as reduced weight and size, and easily manufacture and integration with other systems. However, for some applications, like the IEEE 802.11 standards or Bluetooth, the physical dimension of such planar structures may be too big, turning impossible its integration inside the radio-frequency (RF) devices. The conventional microstrip antenna is formed by a ground plane, a radiating microstrip (or a conducting plane), and a feeding structure. It is known that this conventional antenna operating in its fundamental mode, the transversal magnetic (TM) mode TM₀₁, presents an antenna length of approximately Y₀/2 (where Y₀ is the wavelength in the substrate). The microstrip length is defined based on a wavelength Y₀, associated to the resonating frequency f₀. Several techniques have been proposed to reduce the size of conventional microstrip antenna into half-wavelength, Y₀/2 The most obvious approach consist in using substrates with high dielectric permittivity (e.g. between the ground plane and the microstrip). However, this technique leads usually to low efficiency and bandwidth reduction.

Another technique that has also been used in several applications, in order to reduce the general dimension of the microstrip antenna, is to use a short-circuit by means of metallic walls or vias. Considering that the electric field for the TM₀₁ mode is zero for the radiating microstrip, a short-circuited along its middle line with a metallic wall, without a significant change of the microstrips' operating frequency. This microstrip antenna with short-circuit includes a microstrip with a length of Y₀/4. It is possible to further reduce the antenna dimensions through the usage of a short-circuit close to the feeding point. The technique of reducing the dimensions of the antenna using a shorting pin was, e.g. used with success to design small planar antennas used in portable terminals for the use of the 3G IMT-2000 standard.

One of the best known and documented microstrip antennas of electrically small dimensions, is the planar inverted F antenna (PIFA). Essentially, a PIFA can be seen as a microstrip antenna with a short-circuit. Therefore, the PIFA antenna length is normally minor then Y₀/4. Placing a shorting pin in the proper position, the PIFA length can be reduced to Y₀/8. The PIFA dimension can also be reduced with electrical loading.

Due to limitations of available room, imposed by the dimensions of the integrated circuits and due to the necessity to reduce the device dimensions, there has been for a long time the necessity of developing an antenna with an adequate geometry and dimension for integration inside RF integrated circuits (IC). Until now, the integration of antennas has been mainly based on the usage of the conventional microstrip antenna, being its integration limited to applications at higher frequencies. This happens because most of the proposed solutions to reduce the antenna size do not always impose as restriction the utilization of geometry, materials and manufacturing methods compatible with the integration of such an antenna in an integrated RF IC device.

In this way, the project of compact and fully integrated antennas is still a challenge the industry wishes to solve to allow the development of modern RF devices with wireless communications. Due to the physical limitations associated to RF devices, an integrated antenna must have an electrical small dimension, and must work on a limited ground plane, which has a significant influence on the return losses and may also provoke a reduction of the antennas' front/back ratio.

Several antennas have been proposed with the goal of its size reduction and/or to make them integrable in IC, as follows:

The U.S. Pat. No. 6,727,855 B1—Folded multilayer electrically small microstrip antenna—describes an antenna with reduced dimensions, which is manufactured through the stack of several layers. However, due to the antennas' geometry and structure, its integration, using conventional packaging techniques, is not possible. Furthermore, the use of the simple multilayer technique does not provide an antenna with small enough dimensions for being integrated in an IC. In the U.S. Pat. No. 6,798,383 B2—Low profile small antenna and constructing method therefore—is proposed a planar antenna with reduced dimensions, however the elements that constitute the antenna are neither small enough nor possible for integration in an IC. The U.S. Pat. No. 6,639,557 B2—Small antenna and manufacturing method thereof—describes an antenna and the respective manufacturing method to obtain a device of reduced dimensions. However, this antenna and the respective manufacturing method do not allow its integration in an IC. The U.S. Pat. No. 6,693,604 B2—Small antenna—presents an antenna with small dimensions and compatible with the manufacturing process used for integrated circuits. The main drawback consists in the need of having ground plane that is significantly larger then the antenna itself. This makes its use to integrate in IC impossible.

The European Patents 1445822—Chip antenna—and EP 1460715—Surface mount type chip antenna and communication equipment using the same—also describe a miniaturized antenna to be used in portable devices. However, this antenna has a configuration that is not favourable for integration in an IC. The European Patent EP 1494161—Noncontact IC card reader/writer integrated with antenna—describes a device with an integrated antenna where an inductor was used as an antenna. Generally, this technique only allows wireless communications at short distances and/or for devices where one of the communication systems present an antenna with high gain (an antenna with high physical dimensions and generally connected to a stationary base station), appropriate for communicating with the device integrating the inductance. The European Patent EP 1126522—Packaged integrated circuit with radio frequency antenna—describes an invention where an antenna is co-integrated with an IC. The used antenna is a spiral antenna with the drawback of radiating towards the IC, eventually interfering with it. Moreover, since the antenna is integrated in the circuit package, the manufacturing of this antenna involves the use of a quite expensive manufacturing process for the manufacturing of the packaging of this IC.

The American Patent Application US 2004233107—Packaged integrated antenna for circular and linear polarizations—describes a system with integrated antenna. Despite the cited advantages of possible miniaturization, the materials and geometry needed for its manufacturing are not compatible with the manufacturing processes used for IC. The U.S. Pat. No. 6,818,985—Embedded antenna and semiconductor die on a substrate in a laminate package—describes a system where the antenna is integrated in the IC. In this invention is used a microstrip antenna implemented on the substrate, side-by-side with the IC, inside the package. The drawback is that a conventional microstrip antenna is used, where neither a miniaturization nor a good efficiency are obtained. The U.S. Pat. No. 6,770,955—Shielded antenna in a semiconductor package—describes also an integrable antenna with an IC. The great drawback of this patent is the necessity of using two different packages to connect the antenna with the remaining RF device. The International Patent Application WO 2004042868—Integrated Circuit Package Including Miniature Antenna—foresees the integration of antennas in the IC package. But, as aforementioned, this process is highly unfavourable from the economical point of view, implying the usage of new and expensive packaging processes.

Since the aim is to co-integrate the antenna with the IC, it is of great importance having in mind the last techniques that have been proposed in this field. Namely, the development of techniques allowing to obtain an IC, using wafer level packaging, introducing a new concept of integration and packaging of an IC. This field has been a target of interest, as may be noticed by the U.S. Pat. No. 6,646,289 B1—Integrated circuit device (Nov. 11, 2003)—, U.S. Pat. No. 6,713,870 B2—Wafer level chip-scale package (30/03/2004)—, U.S. Pat. No. 6,777,767 B2—Methods for producing packaged integrated circuit devices & packaged integrated circuit devices produced thereby (17/08/2004)—, U.S. Pat. No. 6,818,475—Wafer level package and the process of the same (16/11/2004)—, U.S. Pat. No. 6,836,018 B2—Wafer level package and method for manufacturing the same (28/12/2004)—e U.S. Pat. No. 6,841,874 B1—Wafer-level chip-scale package (Nov. 1, 2005). All these patents describe techniques for manufacture a packaged IC, without the need of standard packaging process. Particularly, the U.S. Pat. No. 6,777,767 B2—Methods for producing packaged integrated circuit devices & packaged integrated circuit devices produced thereby—describes a method allowing the usage of several stacked silicon wafers in order to obtain the final device.

Up to now, no micro-antenna, suitable for integrating an IC, has been proposed without the drawbacks and limitations related to the antenna dimensions and substrate characteristics used in the IC manufacturing. The present invention makes possible the accomplishment of an antenna small enough to be co-integrated with the IC, without the drawback of IC size increase or performance losses due to substrate characteristics.

In fact, this can be accomplished due to the utilization of at least one die containing a RF circuitry and where the antenna is integrated in the package, using wafer level packaging techniques. This complete device may be used for applications requiring wireless communications, avoiding the need of combining two modules in a printed circuit. In this way, the required area is reduced as well as the tasks related to the interconnection of the antenna module to the RF module, which means a consequent reduction of the overall costs.

The present invention allows using the multilayer antenna concept in such a way that it becomes small enough for integration in an IC. Moreover, accomplishing the need of reducing significantly the electrical dimensions of a plane antenna with the necessary characteristics for integration in an IC, this antenna has also the advantage of being easily tuned.

### SUMMARY OF THE INVENTION

The main goal of the present invention is to provide a multilayer micro-antenna, electrically small, capable of being co-integrated with the RF circuit. This electrically small multilayer micro-antenna allows a significant antenna size reduction and has further the capacity of being tunable.

One goal of the present invention is to provide a micro-antenna that can be integrated in a packaged IC for RF applications, but with smaller dimensions and lower costs, when compared to known devices. This goal is achieved by using an IC for RF implemented in an IC packaging, while the antenna for RF is also integrated in the same package. The full package, including the antenna, can be used for applications requiring wireless communications, such as Blutooth or WiFi technology, instead of the need of combining an RF module with an antenna module in a printed circuit board. In this way, it is possible to reduce the required space on the printed board and for housing the RF application. At the same time, the implementation costs of RF are reduced because, instead of the implementation costs associated to the RF module placement, antenna chip placement and interconnections between them, there are only the placement costs of the RF device with integrated antenna.

A goal of the present invention is also to provide an integrated micro-antenna where the feeding point of the antenna is integrated with the RF circuits.

Another goal of the present invention is to provide a multilayer micro-antenna electrically small that allows a significant size reduction of the antenna, which functions efficiently, is integrable in an IC in a simple way and with low cost and which has the possibility of being tuned.

To fulfil the long time-ago need, and not yet met, for a electrically small antenna efficiently integrated in an IC, the present invention provides a electrically small multilayer microstrip antenna, formed by a stack of substrates, interleaved by metal patches which form, alternately, the ground plane and the radiating strip. The metallic patches forming the radiating strip are provided with slots to allow an extra antenna size reduction, and making possible the tuning of the antenna, and the metallic patch forming the ground plane presents a slot to provide one more possibility of controlling the input impedance of the microstrip antenna.

The embodiments of the invented multilayer micro-antenna include its manufacturing with N substrate layers, being the preferred embodiment the one with three substrate layers. The present invention includes also the manufacturing method of this antenna in a way that turns it integrable in an IC, the way of inserting the slots to reduce significantly the antenna size as well as the method to turn this antenna tunable.

The preferred embodiments of the present invention provide a multilayer microantenna. Briefly, a preferred embodiment of the micro-antenna may be implemented as described next: the micro-antenna comprises a ground plane, a first interconnecting structure in contact with the ground plane, a first conducting plane in contact with the first interconnecting structure, a second interconnecting structure in contact with the ground plane, a second conducting plane in contact with the second interconnecting structure, a third interconnecting structure in contact with the second conducting plane, a third conducting plane in contact with the first interconnecting structure, which forms a radiating aperture together with the second conductor patch.

The preferred embodiments of the present invention include also a method to manufacture the antenna. One of the possible methods can be described, in a general way, by the following steps: formation of the ground plane and of the first conducting plane in a substrate compatible with the IC manufacturing process, interconnection of the first conducting plane with the ground plane trough the formation and metallization of the first short-circuit structure, the first conducting plane is substantially parallel to the ground plane, bonding a second substrate and connecting the second conducting plane formed on the top of this substrate to the ground plane with a second shortcircuit structure, the second conducting plane is substantially parallel to the ground plane, bonding a third substrate and connecting the third conducting plane formed on the top of this substrate to the ground plane with a third short-circuit structure, the third conducting plane is substantially parallel to the second conducting plane, the third conducting plane forms a radiating aperture with the second conducting plane. The steps may, or may not follow the presented sequence, depending on the available technology.

With the present invention, all the available room in the package for integrating the antenna is used, since the antenna structure forms the package. According to the previously proposed techniques, the antenna used only a fraction of the IC or of the package. Moreover, since the present invention is based on a multilayer structure, it is possible to benefit from the stack of several wafers to increase the radiation efficiency, to control the bandwidth or the gain. Since the present invention may be accomplished using wafer level packaging techniques, it is possible to use low loss substrates, what reduces the power penalty associated to the antenna integration. Since the present invention permits the significant reduction of antenna dimensions, it is possible to fabric the antenna using substrates with a smaller dielectric permittivity, improving the antenna radiation features.

The present invention allows accomplishing an antenna integrated in a microsystem without significant degradation of the antenna efficiency. This means, that there is no great power penalty associated to the integration of the antenna, what occurs when considering the direct implementation of a microstrip antenna on a silicon substrate. Furthermore, since the implementation of the present invention is compatible with the manufacturing and integration processes of subsystems that constitute a certain microsystem, after the necessary design phase of the antenna for this microsystem, the antenna manufacturing is achieved at almost zero cost.

The utilization of the present invention allows the antenna placement in a simple way in all Microsystems using wireless communications. Furthermore, since the integration is made along the IC manufacturing process, it allows obtaining more compact and reliable systems, since the whole manufacturing process is made in a clean and controlled environment. The present invention allows also, using available techniques, the accomplishment of a tunable antenna on a frequency band, around the frequency which the antenna was projected to work.

Other systems, methods, characteristics, functionalities and advantages of the present invention will be, or may become apparent for someone with knowledge in this filed after examination of the drawings and the respective detailed descriptions. It is intended that such additional systems, methods, characteristics, functionalities and advantages become included in the present description, be part of the present invention, and become protected by the accompanying claims.

### BRIEF DESCRIPTION OF THE DRAWINGS

Many aspects of the present invention may be better understood with the reference to some drawings. The devices in the drawings are not necessarily at scale. Instead, it is preferred to clear illustrate the main aspects of the present invention. The drawings are included without any limitative aspect and only with the goal to provide a better understanding of the following description:

FIGS. 1A and 1B show a cross view of two possible micro-antenna realizations with a stack of three substrates, compatible with the IC manufacturing process.

FIG. 2A is a perspective view of the micro-antenna fed by means of a substrate via.

FIG. 2B is a perspective view of the micro-antenna fed by means of a slot, which carries out the electromagnetic coupling through the substrate.

FIG. 3 is a perspective view of the micro-antenna with micro-switches, allowing the selection of the antenna operating frequency.

FIG. 4A is a perspective view of the antenna, showing how it is possible to integrate the present invention with the RF circuits of a certain microsystem.

FIG. 4B is a perspective view of the antenna, showing how it is possible to integrate the present invention with the RF circuits of a certain microsystem, integrating also other micro-components in the substrate used to integrate the antenna.

### DETAILED DESCRIPTION OF AN EMBODIMENT OF THE INVENTION

Next, the preferred embodiments of the present invention will be completely described, with reference to the appended drawings. A way to understand the preferred embodiments of the invention include their observation in the context of wireless communication devices and more specifically in the context of antennas for microsystems. However, it should be pointed out that the preferred embodiments also apply to different contexts, such as its application in mobile phones, monitoring sensors and wireless smart cards, within other related examples using antennas for send/receive data through a medium.

Next will be described a structure for the micro-antenna that can be used in a device for personal communications. A method to manufacture the micro-antenna, compatible with the process used for IC manufacturing, will be described, as well as how the slots, allowing the antenna dimension reduction, are inserted as well as how to adjust its input impedance. It will also be described how the switches, allowing the antenna tuning, should be used.

The present invention describes an advantageously configured multi-substrate antenna formed by a multilayer dielectric, interleaved with a ground plane and a radiating strip designed with a proper geometry to provide an electrically small antenna, for turning possible the manufacturing of an antenna integrated in a wireless microsystem capable of working at ISM bands of 2 GHz and 5 GHz. The radiating strip configuration, and the insertion of slots in the geometry of that strip, result in a significant antenna size reduction, when compared to the previously proposed antennas, without the significant limitations associated to the previously proposed integrated antennas.

The physical dimension of any microstrip antenna is determined by the wavelength in the substrate. E.g., the length of a rectangular microstrip antenna is approximately of half wavelength inside the dielectric mean under the radiating strip. To reduce the element or radiating strip dimensions, the substrate dielectric permittivity must be increased significantly, conducing to an inefficient antenna, what is not desired. The invention of this multilayer antenna, with slots in the radiating strip, mainly the insertion of the slots in the radiating strip, turns the electrical dimensions of this antenna extremely small. Moreover, the insertion of a slot close to the feeding point allows inserting a capacitive compensation, needed due to the fact that the insertion of slots turns the antenna impedance highly inductive. The insertion of slots present the additional advantage of allowing the use of switches that open, or close, these slots so that the geometry of the radiating strips are modified. This modifies the antenna operating frequency, obtaining thus a tunable antenna. The slots can also be used to refine the operating frequency of the antenna in an operating control process. Another great advantage of the present invention is the fact of being based on geometric restrictions, turning possible the manufacturing of the antenna using the available IC manufacturing techniques.

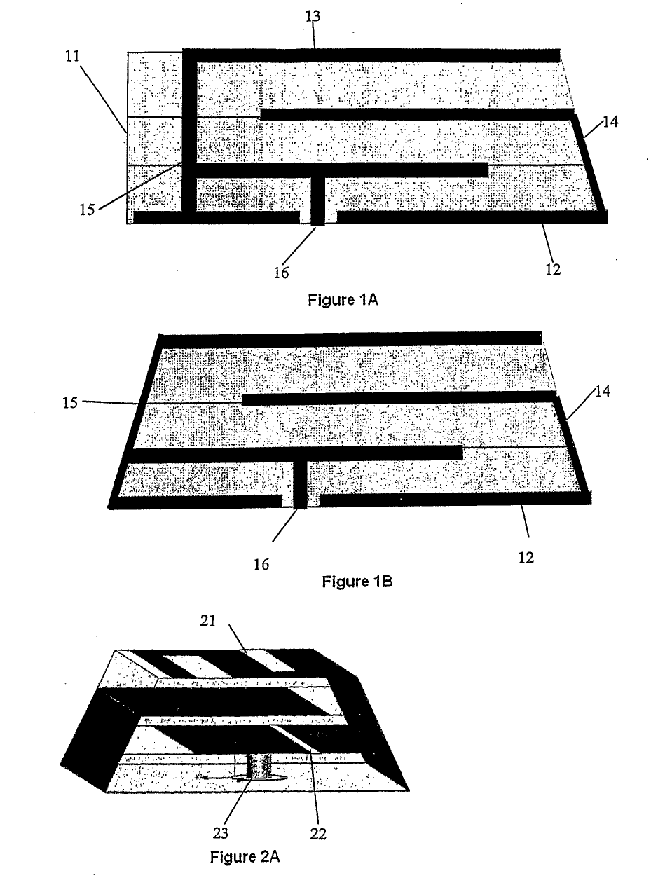

FIG. 1A shows the generic structure of the micro-antenna. The micro-antenna is composed by a structure forming the ground plane (12), a structure forming the radiating strip (13), an interconnection structure to form the ground plane (14), an interconnection structure to form the radiating strip (15) and a feeding structure (16) of the micro-antenna. The metallic materials forming the ground plane, the radiating strip, and the interconnection structures must be compatible with the available IC manufacturing technology. The substrates (11) used are electrically, thermally and mechanically compatible with the materials used in IC manufacturing process.

The internal interconnection structures used to form the ground plane and the radiating strip can be made with a slot, followed by metallization or by a row of metallized vias. The external interconnection structures used to form the ground plane and the radiating strip are obtained trough the metallization on the surface of the antenna substrate, which needs to have a proper angle to allow the metallization.

The antenna feeding may be achieved with a probe (23), which connects directly the antenna input/output to the RF circuits' output/input inside the package. This feeding may also be done by a slot (24), which will allow the electromagnetic coupling between the antenna and a microstrip line interconnecting the antenna and the RF circuits.

The antenna dimensions may be reduced due to the increase of the number of substrate layers (11) but, with this invention, it will be also possible to reduce significantly these dimensions through the insertion of properly positioned slots in the radiating strip (21).

The antenna input impedance may be adjusted by the standard method, moving the position of the feeding point but, with this invention, it can also be adjusted through the positioning and dimensioning of a slot (22). Due to the insertion of slots to significantly reduce the antenna dimensions, this proposed new method to control the input impedance may be the only way to obtain a convenient input impedance.

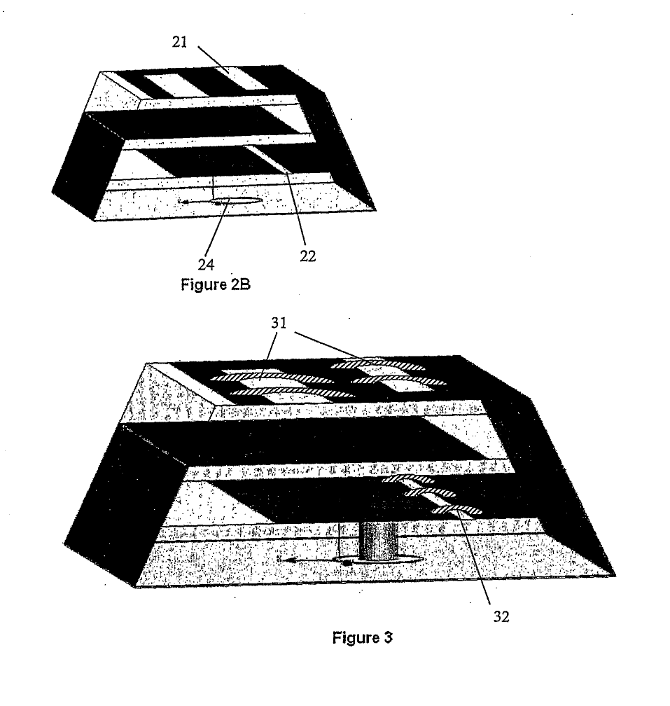

FIG. 3 shows the concept for a tunable antenna, with adjustable impedance. The placement of switches (31) in the radiating strip slots (21) allows the modification of the electric length, what changes the operating frequency. The use of switches (32) in the ground plane slot (22) allows the tuning of the input impedance of the antenna.

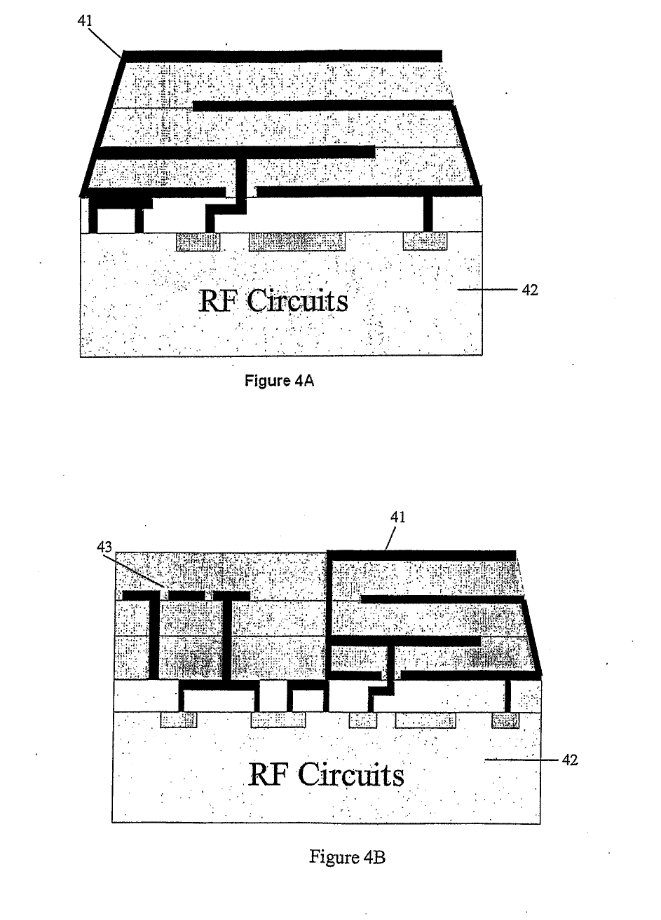

FIGS. 4A and 4B show the antenna integration concept together with the RF IC. In FIG. 4A, the antenna (41) is built using wafer level packaging techniques and connected to the RF circuits (42), using the same techniques, resulting in a wireless RF microsystem with an integrated antenna. FIG. 4B extends the integration concept, where the antenna (41) is connected to the RF IC (42) and the substrate used to manufacture the antenna is also used to integrate other RF components (43).

As an application example, an antenna to operate within the 5 GHz ISM band was designed, and it was verified that the insertion of two slots in the radiating strip allowed an area reduction of 30% necessary for implementing the antenna. The use of this micro-antenna allows its integration in RF IC using only a fraction of the area of conventional antennas, e.g., just 2×2 mm² in the 5 GHz ISM band. It is important to refer that any microsystem packaged uses at least an area of 10×10 mm².

It should be pointed out that the previously described embodiments of the present invention, in particular some of the preferred embodiment, are only possible implementation examples, presented merely to give a clear understanding of the principles of the present invention. The previous embodiments may suffer many variations and modifications, without turning them significantly different regarding the idea and principle of the present invention. All of these modifications and variations must be included in the scope of this divulgation and present invention, and must be protected by the following claims.

1. An integrated, tunable micro-antenna with reduced electrical dimensions, of the micro-stripe multilayer type, characterized for comprising:
(a) a stack of substrates (11) interleaved with a ground plane (12) and a radiating strip (13),
(b) an interconnection structure to form the ground plane (14),
(c) an interconnection structure to form the radiating strip (15),
(d) a micro-antenna feeding structure (16),
(e) a slot (22) in the radiating strip (13) to allow adjusting the antenna input impedance to the feeding line impedance,
(f) slots (21) or absences of metallic regions in the geometry of the radiating strip (13) and in the geometry of the ground plane (14), wherein all these elements are employed in a wafer level packaging process, where the slots (21) of the radiating strip (13) contain switches (31) to change its operating frequency, and the slots (22) of the ground plane (14) contain switches (32) to change the antenna input impedance.

2. The micro-antenna according to claim 1, characterized for both, the interconnection structure for the ground plane (14) and the interconnection structure for the radiating strip (15) being formed by means of a metallic wall or a row of metallized vias, establishing the electric contact between the both sides of a wafer.

3. The micro-antenna according to claim 1, characterized because the micro-antenna feeding is accomplished with a probe (23), which directly connects the antenna input/output to the RF circuits output/input inside the package.

4. The micro-antenna according to claim 1, characterized because the antenna feeding is accomplished with a slot (24), which allows the electromagnetic coupling between the antenna and a feeding microstrip, which will carry out the interconnection between the RF circuits and the micro-antenna.

5. The micro-antenna according to claim 1, characterized for the antenna being coupled to an integrated circuit containing the RF circuits, and where, simultaneously, the antenna substrate is used to integrate other RF devices.

6. A method to manufacture the micro-antenna, according to claim 1, characterized by the formation of the ground plane and the first conducting plane in a substrate compatible with the process used to manufacture the integrated circuits, by the connection of the first conducting plane with the ground plane trough the formation and metallization of the first short-circuit structure, wherein the first conducting plane is substantially parallel to the ground plane, by the bonding of a second substrate and by connecting a second conductor plane formed on the top of this substrate to the ground plane with the formation of a second short-circuit structure, wherein the second conducting plane is substantially parallel to the ground plane, by the bonding of a third substrate and by connecting a third conductor plane formed on the top of this substrate to the ground plane with a third short-circuit structure, wherein the third conducting plane is substantially parallel to the ground plane and by the third conducting plane forming a radiating aperture with the second conducting plane.

7. Radio-frequency integrated circuit characterized for integrating a micro-antenna, according to claim 1.

8. Wireless communication microsystem characterized for integrating an integrated circuit, according to claim 7.

9. Wireless communication microsystem according to claim 8, characterized for having the capacity to operate in the ISM bands of 2 GHz and 5 GHz.
